(19) United States
(12) Patent Application Publication
(10) Pub. No.: US 2026/0110274 A1
(43) Pub. Date: Apr. 23, 2026

(54) PISTON, INTERNAL COMBUSTION ENGINE, AND VEHICLE

(71) Applicant: Isuzu Motors Limited, Yokohama-shi (JP)

(72) Inventor: Kazuya OKAZAKI, Fujisawa-shi (JP)

(73) Assignee: Isuzu Motors Limited, Yokohama-shi (JP)

(21) Appl. No.: 19/335,062

(22) Filed: Sep. 22, 2025

(30) Foreign Application Priority Data
Oct. 22, 2024 (JP) 2024-186095

(51) Int. Cl. F02F 3/22; F01M 1/08; F01M 11/02; F02F 3/28

(52) U.S. Cl. CPC F02F 3/22; F01M 1/08; F01M 11/02; F02F 3/28; F01M 2001/083; F01M 2011/022

(57) ABSTRACT

A piston includes a piston head, a piston skirt and an oil flow path. The piston skirt is provided on a bottom side with respect to the piston head, and a pin hole is formed along an extending direction crossing an up-and-down direction in the piston skirt. The oil flow path extends through the piston head and the piston skirt, and has an opening portion opening to the bottom side in the piston skirt. a dimension of the opening portion along the extending direction of the piston hole is greater than a dimension of the opening portion along a width direction crossing both the up-and-down direction and the extending direction of the pin hole.

### CROSS-REFERENCE TO RELATED APPLICATION

This application is based upon and claims the benefit of priority from prior Japanese Patent Application No. 2024-186095, filed Oct. 22, 2024, the entire contents of which are incorporated herein by reference.

### FIELD

The present invention relates to a piston, an internal combustion engine, and a vehicle.

### BACKGROUND

In an internal combustion engine mounted in a vehicle or the like, a piston reciprocally moves in an up-and-down direction in an internal cavity of a cylinder, and thereby the reciprocal movement of the piston is converted to a rotational movement of a crank shaft. In the piston, a pin hole is formed in a piston skirt, and a piston pin is inserted in the pin hole. In the internal combustion engine, a connecting rod is coupled to the piston via the piston pin interposed.

In addition, there is known an internal combustion engine in which an oil jet is attached to the cylinder, and oil is jetted from the oil jet toward the piston. In this type of internal combustion engine, the piston is, for example, cooled by the oil from the oil jet. In addition, in the internal combustion engine in which the oil jet is provided, an oil flow path is formed in the inside of the piston, and the oil jetted from the oil jet can be caused to flow into the oil flow path. In the piston in which the oil flow path is formed, an inflow portion or the like of the oil from the oil jet is formed in the piston skirt as an opening portion that opens to the bottom side (refer to Jpn. Utility Model Appln. Publication No. S62-122155).

### SUMMARY

According to an aspect of the present invention, a piston includes a piston head, a piston skirt and an oil flow path. The piston skirt is provided on a bottom side with respect to the piston head, and a pin hole is formed along an extending direction crossing an up-and-down direction in the piston skirt. The oil flow path extends through the piston head and the piston skirt, and has an opening portion opening to the bottom side in the piston skirt. a dimension of the opening portion along the extending direction of the piston hole is greater than a dimension of the opening portion along a width direction crossing both the up-and-down direction and the extending direction of the pin hole.

### BRIEF DESCRIPTION OF THE DRAWINGS

FIG. 1 is cross-sectional view schematically illustrating an example of a structure of one piston and the vicinity thereof of an internal combustion engine according to an embodiment.

FIG. 2 is a schematic diagram illustrating the piston of the example of FIG. 1 as viewed from a bottom side.

FIG. 3 is a cross-sectional view schematically illustrating the piston of the example of FIG. 1 by a different cross section from FIG. 1.

FIG. 4 is a schematic diagram illustrating a structure of an opening portion and the vicinity thereof, as viewed from the bottom side, the opening portion forming an inflow portion of an oil flow path in the piston of the example of FIG. 1.

FIG. 5 is a schematic diagram illustrating a structure of an opening portion and the vicinity thereof, as viewed from the bottom side, the opening portion forming an inflow portion of an oil flow path in a piston according to a modification.

FIG. 6 is a schematic diagram illustrating a structure of an opening portion and the vicinity thereof, as viewed from the bottom side, the opening portion forming an inflow portion of an oil flow path in a piston according to a different modification from FIG. 5.

FIG. 7 is a cross-sectional view schematically illustrating a piston according to a different modification from FIG. 5 and FIG. 6.

FIG. 8 is a schematic diagram illustrating an example of a structure of a vehicle in which the internal combustion engine according to the embodiment is mounted.

### DETAILED DESCRIPTION

Hereinafter, an embodiment is described with reference to the accompanying drawings.

In an internal combustion engine mounted in a vehicle or the like, one or more pistons, and the same number of cylinders as the pistons are provided. In addition, each of the one or more pistons reciprocally moves in an up-and-down direction in an internal cavity of a corresponding one of the cylinders. For example, in a 4-cylinder internal combustion engine, four pistons and four cylinders are provided, and each of the four pistons reciprocally moves in an internal cavity of a corresponding one of the four cylinders. In the internal combustion engine, each of the one or more pistons is coupled to a crank shaft via a connecting rod interposed. In addition, by the one or more pistons reciprocally moving, the crank shaft rotates. Specifically, the reciprocal movement of the piston is converted to the rotational movement of the crank shaft. In the embodiment, at least one piston provided in the internal combustion engine has a structure to be described below. In addition, the structure to be described below is applicable to each of a diesel engine and a gasoline engine.

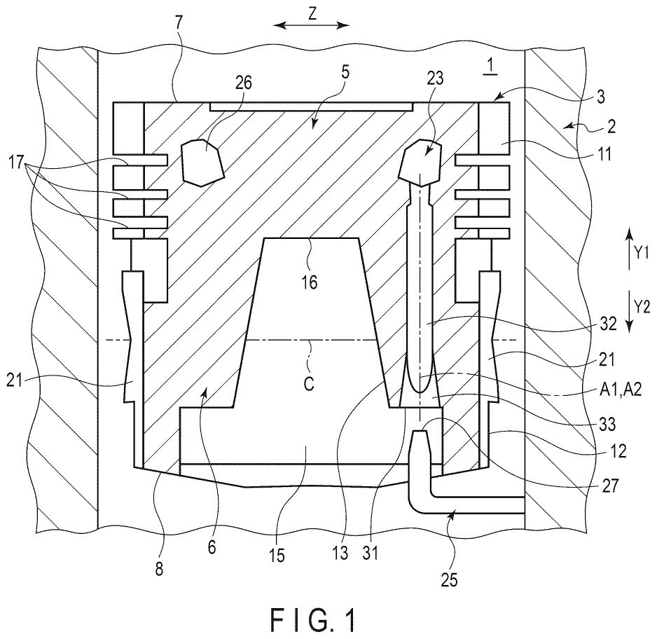

FIG. 1 is cross-sectional view schematically illustrating an example of a structure of one piston 3 and the vicinity thereof of an internal combustion engine 1 according to the embodiment. As illustrated in FIG. 1, the internal combustion engine 1 includes a cylinder 2 and the piston 3. In the internal combustion engine 1 and the piston 3, an up-and-down direction (direction indicated by arrow Y1 and arrow Y2), and a front-and-rear direction (direction indicated by arrow Z) crossing (perpendicular or substantially perpendicular to) the up-and-down direction are defined. FIG. 1 illustrates a cross section along both the up-and-down direction and the front-and-rear direction. In the internal combustion engine 1 and the piston 3, one side of the up-and-down direction is referred to as a top side (arrow Y1 side), and the opposite side to the top side of the up-and-down direction is referred to as a bottom side (arrow Y2 side).

The cylinder 2 is formed in a cylindrical shape having a center axis extending along the up-and-down direction, and the piston 3 is disposed in an internal cavity of the cylinder 2. The piston 3 reciprocally moves in the internal cavity of the cylinder 2 in the up-and-down direction. Thus, the up-and-down direction is also referred to as a reciprocal movement direction of the piston 3, and as a moving direction of the piston 3. In the internal combustion engine 1, a suction port (not illustrated) and an exhaust port (not illustrated) are disposed on the top side with respect to the piston 3. In addition, a combustion chamber is formed by a space between each of the suction port and exhaust port and the piston 3. Besides, in the internal combustion engine 1, a crank shaft (not illustrated) is disposed on the bottom side with respect to the piston 3.

In the internal combustion engine 1, for example, a cycle operation, in which four steps of a suction step, a compression step, an expansion step and an exhaust step constitute one cycle, is repeatedly performed. In the suction step of the internal combustion engine 1, gas is introduced from the suction port into the combustion chamber of the internal cavity of the cylinder 2, and the piston 3 moves up to a bottom dead point toward the bottom side. Then, in the compression step, the piston 3 moves from the bottom dead point up to a top dead point toward the top side. The top dead point, at which the piston 3 arrives by the compression step, is also referred to a compression top dead point. In the cycle operation of the diesel engine, the temperature of the combustion chamber rises to a high temperature in the compression step, and the gas in the combustion chamber is ignited by the jet of diesel oil into the combustion chamber at any one of time points of the compression top dead point and a period immediately near the compression top dead point, and thereby the gas in the combustion chamber is burnt. On the other hand, in the cycle operation of the gasoline engine, gasoline, together with gas, is introduced into the combustion chamber in the suction step, and the gas in the combustion chamber is ignited by an ignition plug or the like at any one of time points of the compression top dead point and the period immediately near the compression top dead point, and thereby the gas in the combustion chamber is burnt. Further, in the expansion step, the piston 3 moves from the compression top dead point up to the bottom dead point toward the bottom side. Then, in the exhaust step, the piston 3 moves from the bottom dead point up to the top dead point toward the top side, and the gas is exhausted from the exhaust port into the internal cavity of the cylinder 2. By the internal combustion engine 1 performing the cycle operation as described above, the piston 3 reciprocates twice between the top dead point and the bottom dead point and moves with four strokes during one cycle.

The piston 3 includes a piston head 5 and a piston skirt 6. The piston skirt 6 is provided on the bottom side with respect to the piston head 5. In the example of FIG. 1, the piston skirt 6 is coupled to the piston head 5 from the bottom side. In addition, in the piston 3, an end surface (upper end surface) 7 on the top side is formed by the piston head 5, and an end surface (lower end surface) 8 on the bottom side is formed by the piston skirt 6. Besides, in the example of FIG. 1, the piston head 5 is formed in a columnar shape with an outer peripheral portion 11, and the piston skirt 6 is formed in a cylindrical shape with an outer peripheral portion 12 and an inner peripheral portion 13. In the reciprocal movement of the piston 3, the outer peripheral portion 11 of the piston head 5 and the outer peripheral portion 12 of the piston skirt 6 slide relative to the inner peripheral portion of the cylinder 2 in the up-and-down direction. In the piston 3 of the example of FIG. 1, a space 15 is formed on the inner peripheral side of the piston skirt 6, and the space 15 is covered by the piston skirt 6 over the entire circumference of the circumferential direction of the piston 3. In addition, the space 15 opens toward the bottom side, and a lower surface 16 of the piston head 5 neighbors the space 15 from the top side.

Ring grooves 17 that are recessed to the inner peripheral side are formed in the outer peripheral portion 11 of the piston head 5, and in the example of FIG. 1, three ring grooves 17 are formed. Each of the ring grooves 17 extends along the circumferential direction of the piston 3, and is formed over the entire circumference in the circumferential direction. In addition, in the structure in which a plurality of ring grooves 17 are formed, the ring grooves 17 are disposed by being spaced apart from each other in the up-and-down direction. A piston ring (not illustrated) is attached to each of the ring grooves 17. Note that the number of ring grooves 17 formed in the piston head 5 is adjusted to an appropriate number in accordance with the internal combustion engine 1 in which the piston 3 is used.

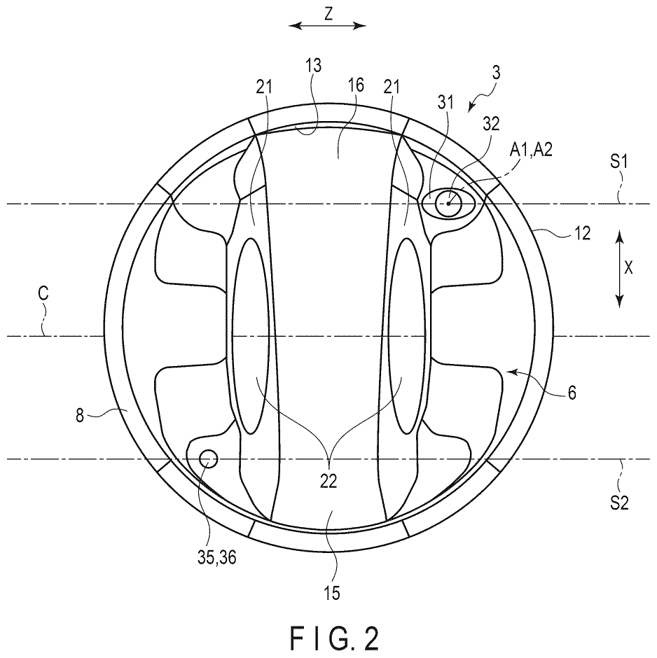

FIG. 2 is a schematic diagram illustrating the piston 3 of the example of FIG. 1 as viewed from the bottom side. A cross section S1 in FIG. 2 is illustrated in FIG. 1. As illustrated in FIG. 1 and FIG. 2, the piston skirt 6 includes a pair of pin boss portions 21. The paired pin boss portions 21 are disposed by being spaced apart from each other in the front-and-rear direction, and are opposed to each other with the space 15 being interposed. In addition, the paired pin boss portions 21 are disposed by being distanced from each other by a half or a substantially half circumference in the circumferential direction of the piston 3. A pin hole 22 is formed in each of the paired pin boss portions 21, and each of the paired pin holes 22 penetrates the piston skirt 6 from the outer peripheral portion 12 to the inner peripheral portion 13. In each of the pin boss portions 21, the pin hole 22 extends in the front-and-rear direction. In addition, a center axis C of each of the pin holes 22 extends along the front-and-rear direction. Thus, the front-and-rear direction is also referred to as the extending direction of the pin hole 22, as the penetration direction of the pin hole 22, and as the axial direction of the pin hole 22.

In the internal combustion engine 1, a piston pin (not illustrated) is passed through each of the pin holes 22, and the piston pin is attached in the pin holes 22 of the piston skirt 6. In addition, the piston 3 is coupled to a connecting rod (not illustrated) via the piston pin. Thereby, the piston pin 3 is coupled to the crank shaft via the piston pin and the connecting rod interposed. Besides, in the cycle operation of the internal combustion engine 1, the piston 3 pivots around the piston pin in parallel with the above-described reciprocal movement. The pivotal movement of the piston around the piston pin is also referred to as an oscillation movement. The pivotal axis of the piston in the oscillation movement is coaxial or substantially coaxial with the center axis of the piston pin, and is coaxial or substantially coaxial with the center axis C of each of the pin holes 22.

Besides, in the piston 3, a width direction (direction indicated by arrow X), which crosses (perpendicular or substantially perpendicular to) both the up-and-down direction (reciprocal movement direction) and the front-and-rear direction (the extending direction of the pin holes 22), is defined. In the internal combustion engine 1, the piston 3 is inclined with respect to the up-and-down direction from a neutral state along the up-and-down direction (the center axis of the cylinder 2) by the above-described oscillation movement. In the neutral state, one side of the width direction of the piston 3 coincides or substantially coincides with a thrust side, and an opposite side to the thrust side in the width direction of the piston 3 coincides or substantially coincides with an anti-thrust side. Thus, the width direction of the piston 3 is also referred to as a thrust-anti-thrust direction. Note that FIG. 1 illustrates a cross section perpendicular or substantially perpendicular to the width direction of the piston 3.

In the internal combustion engine 1, a lateral pressure occurs between the piston 3 and the cylinder 2 by the piston 3 being inclined with respect to the up-and-down direction by the oscillation movement. At the compression top dead point and the period immediately near the compression top dead point, which include a change time from the compression step to the expansion step, a part on the top side with respect to the pin holes 22 pivot toward the anti-thrust side with respect to the position in the neutral state. Further, immediately after the compression top dead point, a maximum lateral pressure occurs on the thrust side with respect to the center axis of the cylinder 2.

As illustrated in FIG. 1 and FIG. 2, in the piston 3, an oil flow path 23 extends through the piston head 5 and the piston skirt 6. In the internal combustion engine 1, an oil jet 25 that can jet oil is attached to the cylinder 2. The oil jet 25 includes a jet port 27, and jets oil from the jet port 27. The oil jet 25 is disposed in the internal cavity of the cylinder 2 on the bottom side with respect to the piston 3. By the piston 3 moving toward the bottom dead point by the above-described reciprocal movement, the piston 3 approaches the oil jet 25. On the other hand, by the piston 3 moving toward the top dead point, the piston 3 moves away from the oil jet 25. FIG. 1 illustrates a state in which the piston 3 is located at the bottom dead point or near the bottom dead point.

In the internal cavity of the cylinder 2, the oil jet 25 jets oil toward the top side, and jets the oil toward the piston 3 that is reciprocally moving. By the oil from the oil jet 25, the piston 3 is cooled, and the lubricity of the piston 3 is improved. The jet amount of oil from the oil jet 25 varies in accordance with the pressure in the internal cavity of the cylinder 2. For example, in the period in which the gas in the combustion chamber is burning at the compression top dead point and immediately thereafter, the jet amount of oil from the oil jet 25 increases, compared to the other periods. In the state in which the piston 3 is located at the bottom dead point and near the bottom dead point, that is, at a timing when the piston 3 has approached the oil jet 25, the oil jet 25 can cause the jetted oil to flow into the oil flow path 23 of the piston 3. Note that in the state in which the piston 3 is located at a certain distance from the oil jet 25 to the top side, the oil jetted from the oil jet 25 does not flow into the oil flow path 23.

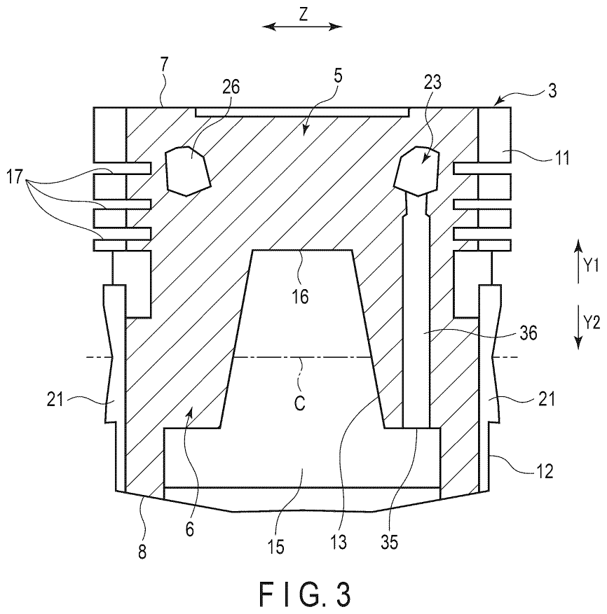

FIG. 3 is a cross-sectional view schematically illustrating the piston 3 of the example of FIG. 1 by a different cross section from FIG. 1. FIG. 3 illustrates a cross section that is perpendicular or substantially perpendicular to the width direction of the piston 3 and is displaced from the cross section of FIG. 1 in the width direction of the piston 3. Specifically, in FIG. 3, a cross section S2 of FIG. 2 is illustrated. As illustrated in FIG. 1 and FIG. 3, the oil flow path 23 includes a cooling chamber 26 that is formed in the inside of the piston head 5. In the piston head 5, the cooling chamber 26 is formed between the end surface 7 on the top side of the piston 3 and the lower surface 16 of the piston head 5 in the up-and-down direction. In addition, the cooling chamber 26 is formed on the inner peripheral side of the piston 3 with respect to the ring grooves 17. In the example of FIG. 1 and FIG. 3, the cooling chamber 26 extends along the circumferential direction of the piston 3. Further, the cooling chamber 26 is formed over the entire circumference in the circumferential direction, and extends around in an annular shape in the circumferential direction.

Besides, as illustrated in FIG. 1 to FIG. 3, the oil flow path 23 includes opening portions 31 and 35 to the outside. Each of the opening portions 31 and 35 opens to the bottom side in the piston skirt 6. In the example of FIG. 1 to FIG. 3, each of the opening portions 31 and 35 is located on the top side with respect to the end surface 8 on the bottom side of the piston 3, and opens toward the space 15. Furthermore, the oil flow path 23 includes communication paths 32 and 36. The communication path 32 establishes communication between the opening portion 31 and the cooling chamber 26, and extends from the opening portion 31 toward the cooling chamber 26 to the top side. In addition, the communication path 36 establishes communication between the opening portion 35 and the cooling chamber 26, and extends from the opening portion 35 toward the cooling chamber 26 to the top side. Note that FIG. 1 illustrates a cross section passing through the opening portion 31 and the communication path 32, and FIG. 3 illustrates a cross section passing through the opening portion 35 and the communication path 36.

In the example of FIG. 1 to FIG. 3, the opening portion 35 and the communication path 36 are located away from the opening portion 31 and the communication path 32 both in the extending direction of the pin holes 22 and in the width direction of the piston 3. In addition, the opening portion 35 and the communication path 36 are disposed by being distanced from the opening portion 31 and the communication path 32 by a half or a substantially half circumference in the circumferential direction of the piston 3. However, in one example, such a configuration may be adopted that the opening portion 35 and the communication path 36 are disposed by being distanced from the opening portion 31 and the communication path 32 in regard to the extending direction of the pin holes 22, but are not displaced, or not substantially displaced, from the opening portion 31 and the communication path 32 in regard to the width direction of the piston 3. Besides, in one example, such a configuration may be adopted that the opening portion 35 and the communication path 36 are disposed by being distanced from the opening portion 31 and the communication path 32 in regard to the width direction of the piston 3, but are not displaced, or not substantially displaced, from the opening portion 31 and the communication path 32 in regard to the extending direction of the pin holes 22.

As illustrated in FIG. 1, in the state in which the piston 3 is located at the bottom dead point or near the bottom dead point, the oil jet 25 is inserted in the space 15 from the bottom side, and the jet port 27 is opposed to the opening portion 31 from the bottom side in the space 15. In addition, in the state in which the piston 3 is located at the bottom dead point or near the bottom dead point, the oil jet 25 jets oil toward the opening portion 31, and the oil from the oil jet 25 flows into the oil flow path 23 through the opening portion 31. Thus, the opening portion 31 forms an inflow portion through which the oil from the oil jet 25 flows into the oil flow path 23. The oil flowing in from the opening portion 31 flows toward the cooling chamber 26 through the communication path 32.

In addition, in the state in which the oil is flowing into the oil flow path 23 from the opening portion 31, the oil that has flown through the cooling chamber 26 flows toward the opening portion 35 through the communication path 36. Then, the oil flows out from the oil flow path 23 through the opening portion 35. Thus, the opening portion 35 forms an outflow portion through which the oil flows out from the oil flow path 23. Since the oil flows in the oil flow path 23 as described above, the opening portion 31 is also referred to as an inflow port, and the communication path 32 is also referred to as an inflow-side communication path. Besides, the opening portion 35 is also referred to as an outflow port, and the communication path 36 is also referred to as an outflow-side communication path. Note that in the state in which the oil does not flow into the oil flow path 23 from the opening portion 31, the oil flows toward the opening portion 31 from the cooling chamber 26 through the communication path 32. In this case, the oil flows out from the oil flow path 23 through the opening portion 31.

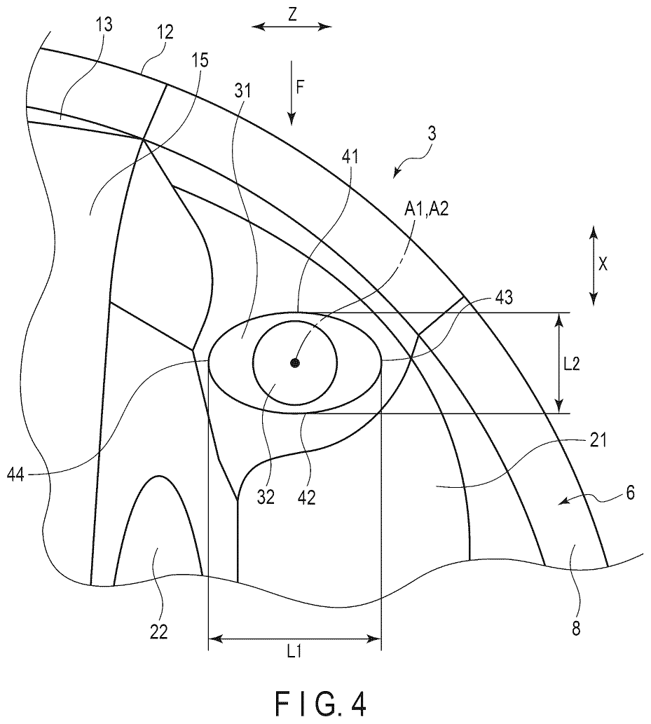

FIG. 4 is a schematic diagram illustrating a structure of the opening portion 31 and the vicinity thereof, as viewed from the bottom side, the opening portion 31 forming the inflow portion of the oil flow path 23 in the piston 3 of the example of FIG. 1. FIG. 4 illustrates, in enlarged scale, the part of the opening portion 31 and the vicinity thereof in FIG. 2. In the example of FIG. 2 and FIG. 4, the opening portion (inflow port) 31 is formed in an elliptic shape having a major-axis direction extending along the extending direction of the pin holes 22, and a minor-axis direction extending along the width direction of the piston 3. Thus, a dimension L1 of the opening portion 31 along the extending direction of the pin holes 22 is greater than a dimension L2 of the opening portion 31 along the width direction of the piston 3.

In addition, an opening edge surrounding the opening portion 31 includes parts 41 and 42 that are adjacent to the opening portion 31 from the width direction, and parts 43 and 44 that are adjacent to the opening portion 31 from the extending direction (front-and-rear direction) of the pin holes 22. The part 41 is adjacent to the opening portion 31 from one side of the width direction, and the part 42 is adjacent to the opening portion 31 from an opposite side to the part 41 in the width direction. Further, the parts 41 and 42 are opposed to each other, with the opening portion 31 being interposed. On the other hand, the part 43 is adjacent to the opening portion 31 from one side of the front-and-rear direction, and the part 44 is adjacent to the opening portion 31 from an opposite side to the part 43 in the front-and-rear direction. Further, the parts 43 and 44 are opposed to each other, with the opening portion 31 being interposed. In the example of FIG. 2 and FIG. 4, since the opening portion 31 is formed in the above-described elliptic shape, the parts 41 to 44 are formed in curved shapes, and are formed in arcuate shapes projecting toward a side away from a center axis A1 of the opening portion 31. Besides, the radius of curvature of each of the parts 41 and 42 is greater than the radius of curvature of each of the parts 43 and 44.

In addition, in the example of FIG. 1 to FIG. 4, the cross-sectional shape of the communication path 32 is formed in a circular or substantially circular shape. Besides, the diameter of the circular shape, which is the cross-sectional shape of the communication path 32, is small, compared to the major axis of the elliptic shape of the opening portion 31. In the oil passage 23, a cross-sectional-shape varying portion 33 is formed between the opening portion 31 and the communication path 32. In the cross-sectional-shape varying portion 33, the cross-sectional shape of the oil passage 23 varies gradually between the elliptic shape of the opening portion 31 and the circular shape that is the cross-sectional shape of the communication path 32. Furthermore, in the example of FIG. 1 to FIG. 4, the center axis A1 of the opening portion 31 is coaxial or substantially coaxial with a center axis A2 of the communication path 32. Thus, the opening portion 31 is formed to be coaxial or substantially coaxial with the communication path 32. Note that in the example of FIG. 1 to FIG. 4, the opening portion 35 that forms the outflow portion is formed in a circular or substantially circular shape. In addition, the cross-sectional shape of the communication path 36 is a congruent or substantially congruent circular or substantially circular shape with the opening portion 35. Besides, the opening portion 35 is formed to be coaxial or substantially coaxial with the communication path 36.

As described above, in the embodiment and the like, the opening portion 31 of the oil flow path 23 opens to the bottom side in the piston skirt 6, and the dimension L1 of the opening portion 31 along the extending direction of the pin holes 22 is greater than the dimension L2 of the opening portion 31 along the width direction of the piston 3. By this structure, a region where the thickness of the piston skirt 6 is small is enlarged in the vicinity of the opening portion 31. In the cycle operation of the internal combustion engine 1, a load F acts on the piston 3 from the width direction. The load F includes a lateral pressure between the piston 3 and the cylinder 2, and a rotational force by the oscillation movement. In the embodiment and the like, since the region where the thickness of the piston skirt 6 is small is enlarged as described above, the rigidity to the load F in the piston skirt 6 is decreased (relaxed). In particular, in the vicinity of the opening portion 31, the rigidity of the piston skirt 6 is decreased. By the decrease in rigidity in the piston skirt 6, the frictional loss in the reciprocal movement of the piston 3 is decreased.

Additionally, in one example of the embodiment, in the opening edge of the opening portion 31 of the oil flow path 23, the radius of curvature of each of the parts 41 and 42 that are adjacent to the opening portion 31 from the width direction of the piston 3 is greater than the radius of curvature of each of the parts 43 and 44 that are adjacent to the opening portion 31 from the extending direction of the pin holes 22. By the increase of the radius of curvature of each of the parts 41 and 42, even if the piston skirt 6 receives the load F from the width direction, the reaction force from the piston skirt 6 against to the load F is decreased. Since the reaction force from the piston skirt 6 against to the load F is decreased, the rigidity to the load F in the piston skirt 6 is further decreased.

Additionally, in the example of FIG. 1 to FIG. 4, the opening portion 31 of the oil flow path 23 is formed in the elliptic shape having the major-axis direction extending along the extending direction of the pin holes 22. Thus, in the opening portion 31, the structure in which the dimension L1 is greater than the dimension L2 is appropriately achieved, and in the opening edge of the opening portion 31, the structure in which the radius of curvature of each of the parts 41 and 42 is greater than the radius of curvature of each of the parts 43 and 44 is appropriately achieved.

Additionally, in one example of the embodiment, the opening portion 31 serving as the inflow port is formed to be coaxial with the communication path 32. By this structure, it is possible to appropriately prevent the oil, which has flown into the oil flow path 23 from the opening portion 31, from flowing backward due to impingement against a wall surface, or the like. Thereby, the oil that has flown in from the opening portion 31 can easily reach the cooling chamber 26, and the collection efficiency of oil is improved.

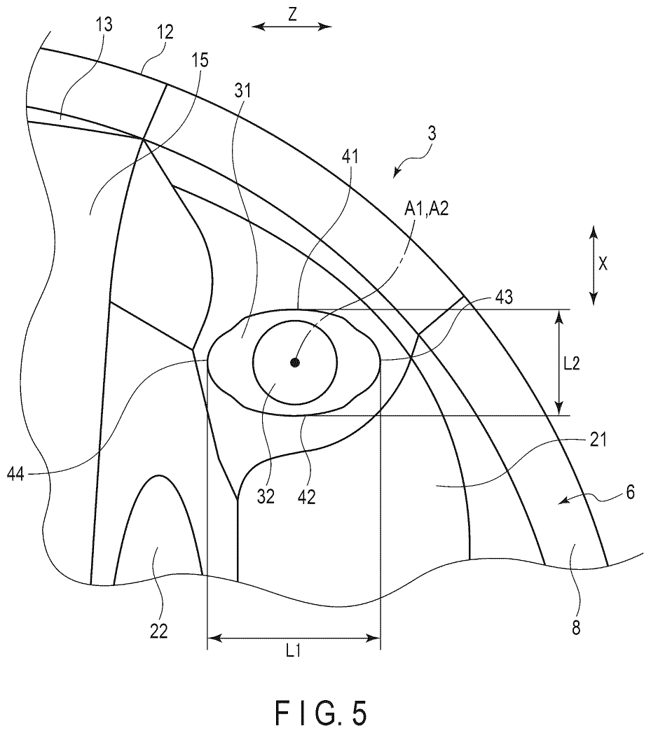

FIG. 5 is a schematic diagram illustrating a structure of the opening portion 31 and the vicinity thereof, as viewed from the bottom side, the opening portion 31 forming the inflow portion of the oil flow path 23 in the piston 3 according to a modification. Also in the modification of FIG. 5, the dimension L1 of the opening portion 31 along the extending direction of the pin holes 22 is greater than the dimension L2 of the opening portion 31 along the width direction of the piston 3. In addition, the opening edge of the opening portion 31 includes parts 41 and 42 that are adjacent to the opening portion 31 from the width direction, and parts 43 and 44 that are adjacent to opening portion 31 from the extending direction (front-and-rear direction) of the pin holes 22, and each of the parts 41 to 44 is formed in an arcuate shape (curved shape) projecting toward a side away from the center axis A1 of the opening portion 31. However, in the present modification, the opening portion 31 is not formed in an elliptic shape. Moreover, in the opening edge of the opening portion 31, a straight part is formed between the part 41 and each of the parts 43 and 44, and a straight part is formed between the part 42 and each of the parts 43 and 44.

In the present modification, like the above-described embodiment and the like, in the opening edge of the opening portion 31, the radius of curvature of each of the parts 41 and 42 that are adjacent to the opening portion 31 from the width direction is greater than the radius of curvature of each of the parts 43 and 44 that are adjacent to the opening portion 31 from the extending direction (front-and-rear direction) of the pin holes 22. Because of the above-described structure, also in the present modification, the region where the thickness of the piston skirt 6 is small is enlarged in the vicinity of the opening portion 31, and the reaction force from the piston skirt 6 against to the load F from the width direction is decreased. Accordingly, in the present modification, like the above-described embodiment and the like, the rigidity of the piston skirt 6 is decreased (relaxed).

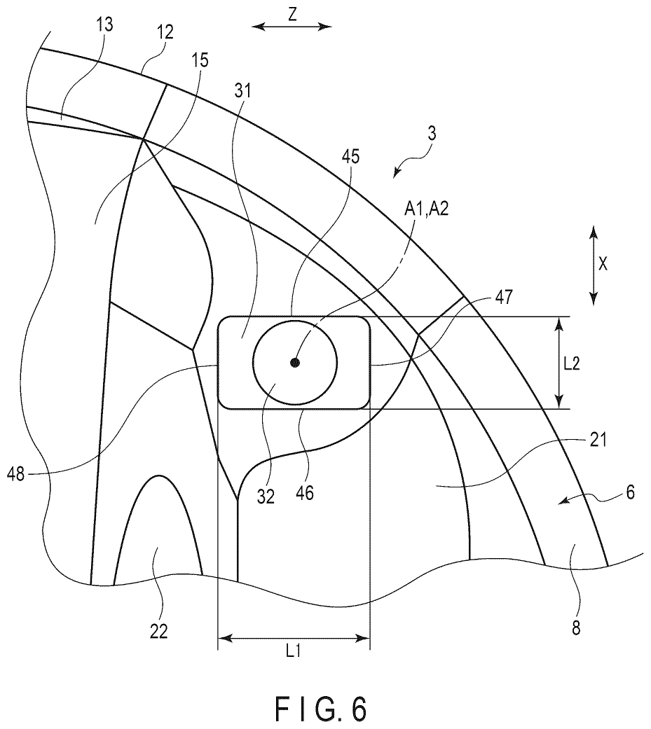

FIG. 6 is a schematic diagram illustrating a structure of the opening portion 31 and the vicinity thereof, as viewed from the bottom side, the opening portion 31 forming the inflow portion of the oil flow path 23 in the piston 3 according to a modification different from the modification of FIG. 5. In the modification of FIG. 6, the opening portion 31 is formed in a rounded-cornered rectangular shape. In addition, the opening edge of the opening portion 31 includes a pair of long-side edges 45 and 46 as the parts that are adjacent to the opening portion 31 from the width direction, and a pair of short-side edges 47 and 48 as the parts that are adjacent to the opening portion 31 from the extending direction (front-and-rear direction) of the pin holes 22. In the present modification, in the rounded-cornered rectangular shape of the opening portion 31, the long-side edges 45 and 46 extend along the extending direction of the pin holes 22, and the short-side edges 47 and 48 extend along the width direction of the piston 3. Accordingly, in the opening portion 31, the long-side direction of the rounded-cornered rectangular shape extends along the front-and-rear direction of the piston 3 (the extending direction of the pin holes 22).

Because of this structure, also in the present modification, the dimension L1 of the opening portion 31 along the extending direction of the pin holes 22 is greater than the dimension L2 of the opening portion 31 along the width direction of the piston 3. Thus, also in the present modification, the region where the thickness of the piston skirt 6 is small is enlarged in the vicinity of the opening portion 31. Accordingly, in the present modification, like the above-described embodiment and the like, the rigidity of the piston skirt 6 is decreased.

Note that in the embodiment and the like, the shape of the opening portion 31 that forms the inflow portion is not particularly limited, if the structure is adopted in which the dimension L1 of the opening portion 31 along the extending direction of the pin holes 22 is greater than the dimension L2 of the opening portion 31 along the width direction of the piston 3. For example, if the dimension L1 is greater than the dimension L2, the opening portion 31 may have a rounded-cornered polygonal shape such as a rounded-cornered triangular shape, other than the rounded-cornered rectangular shape. By adopting the structure in which the dimension L1 is greater than the dimension L2, the region where the thickness of the piston skirt 6 is small is enlarged in the vicinity of the opening portion 31, and the rigidity to the load F in the piston skirt 6 is decreased. Besides, in the embodiment and the like, it is preferable that in the opening edge of the opening portion 31, the radius of curvature of the part (e.g., 41, 42) that is adjacent to the opening portion 31 from the width direction is greater than the radius of curvature of the part (e.g., 43, 44) that is adjacent to the opening portion 31 from the extending direction of the pin holes 22. By this structure, the reaction force from the piston skirt 6 against to the load F from the width direction is decreased, and the rigidity to the load F in the piston skirt 6 is further decreased.

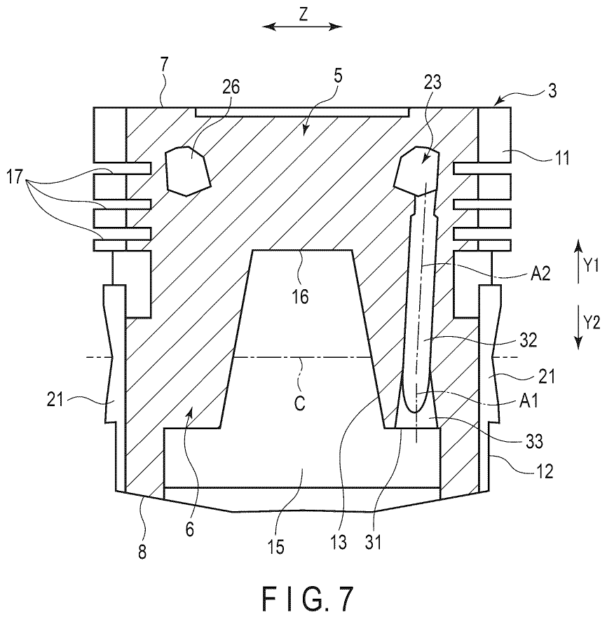

FIG. 7 is a cross-sectional view schematically illustrating a piston 3 according to a different modification from FIG. 5 and FIG. 6. FIG. 7 illustrates a cross section that is perpendicular or substantially perpendicular to the width direction of the piston 3 and passes through the opening portion 31 and the communication path 32. Also in the modification of FIG. 7, the dimension L1 of the opening portion 31 along the extending direction of the pin holes 22 is greater than the dimension L2 of the opening portion 31 along the width direction of the piston 3. In addition, the opening portion 31 that forms the inflow portion is formed in an appropriate shape in which the dimension L1 is greater than the dimension L2, and, in one example, the opening portion 31 is formed in an elliptic shape, like the example of FIG. 1.

In the present modification, the center axis A2 of the communication path 32 is inclined with respect to the up-and-down direction and the center axis A1 of the opening portion 31. Thus, the center axis A1 of the opening portion 31 is not coaxial with the center axis A2 of the communication path 32, and the opening portion 31 is not formed to be coaxial with the communication path 32. Also in the present modification, since the dimension L1 is greater than the dimension L2, the region where the thickness of the piston skirt 6 is small is enlarged in the vicinity of the opening portion 31, and the rigidity to the load F in the piston skirt 6 is decreased.

In the embodiment and the like, if the opening portion 31 is configured such that the dimension L1 is greater than the dimension L2, the opening portion 31 may not be formed to be coaxial with the communication path 32, as in the modification of FIG. 7. However, in the embodiment and the like, it is preferable that the opening portion 31 is formed to be coaxial or substantially coaxial with the communication path 32. By adopting this structure, the oil that has flown in from the opening portion 31 can easily reach the cooling chamber 26, and the collection efficiency of oil is improved.

Additionally, in the above-described embodiment and the like, the cross-sectional shape of the communication path 32 is different from the shape of the opening portion 31. However, in one modification, the cross-sectional shape of the communication path 32 may be congruent or substantially congruent with the shape of the opening portion 31. In one example, like the example of FIG. 1 to FIG. 4, or the like, the opening portion 31 is formed in the elliptic shape having the major-axis direction extending along the extending direction of the pin holes 22. In addition, the cross-sectional shape of the communication path 32 is a congruent or substantially congruent elliptic shape with the opening portion 31.

Additionally, in the above-described embodiment and the like, the opening portion 35 that forms the outflow portion opens in the piston skirt 6, but the embodiment and the like are not limited to this. In one modification, the opening portion 35 opens to the bottom side in the lower surface 16 of the piston head 5. In this case, too, the opening portion 31 that forms the inflow portion is formed in a shape similar to any one of the shapes of the above-described embodiment and the like. Thus, also in the present modification, the dimension L1 of the opening portion 31 along the extending direction of the pin holes 22 is greater than the dimension L2 of the opening portion 31 along the width direction of the piston 3.

Additionally, in one modification, the opening portion 35 that serves as the outflow port opens to the bottom side in the piston skirt 6. Besides, instead of forming the opening portion 31 that serves as the inflow port in any of the above-described shapes, or in addition to forming the opening portion 31 in any of the above-described shapes, the opening portion 35 is formed in a shape described below. Specifically, in the present modification, the dimension of the opening portion 35 along the extending direction of the pin holes 22 is greater than the dimension of the opening portion 35 along the width direction of the piston 3. By this structure, the region where the thickness of the piston skirt 6 is small is enlarged in the vicinity of the opening portion 35 that forms the outflow portion, and the rigidity to the load F in the piston skirt 6 is decreased.

Additionally, in the present modification, it is preferable that in the opening edge of the opening portion 35, the radius of curvature of the part that is adjacent to the opening portion 35 from the width direction of the piston 3 is greater than the radius of curvature of the part that is adjacent to the opening portion 35 from the extending direction of the pin holes 22. In this case, the opening portion 35 is formed, for example, in the elliptic shape having the major-axis direction extending along the extending direction of the pin holes 22. By this structure, the reaction force from the piston skirt 6 against to the load F from the width direction is decreased, and the rigidity to the load F in the piston skirt 6 is further decreased.

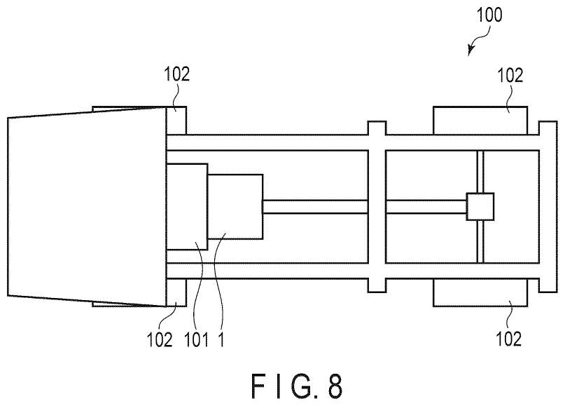

Besides, the internal combustion engine 1 including the above-described piston 3 is mounted, for example, in a vehicle. FIG. 8 is a schematic diagram illustrating an example of a structure of a vehicle 100 in which the internal combustion engine 1 according to the embodiment is mounted. As illustrated in FIG. 8, the vehicle 100 includes the internal combustion engine 1, a transmission 101, and at least one wheel 102. In the example of FIG. 8, a 4-wheel vehicle including four wheels 102 is illustrated, but the number of wheels 102 is not particularly limited. In the vehicle 100, by the internal combustion engine 1 performing the cycle operation, driving force is transmitted to one or more of the at least one wheel 102 via the transmission 101. The vehicle 100 can travel by the driving force being transmitted to one or more of the at least one wheel 102. In a case where four wheels 102 are provided as illustrated in the example of FIG. 8, either two-wheel drive in which driving force is transmitted to two wheels 102, or four-wheel drive in which driving force is transmitted to the four wheels 102, may be adopted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A piston comprising:
a piston head;
a piston skirt which is provided on a bottom side with respect to the piston head, and in which a pin hole is formed along an extending direction crossing an up-and-down direction; and
an oil flow path extending through the piston head and the piston skirt, and having an opening portion that opens to the bottom side in the piston skirt, a dimension of the opening portion along the extending direction of the piston hole being greater than a dimension of the opening portion along a width direction crossing both the up-and-down direction and the extending direction of the pin hole.

2. The piston of claim 1, wherein in an opening edge of the opening portion of the oil flow path, a radius of curvature of a part that is adjacent to the opening portion from the width direction is greater than a radius of curvature of a part that is adjacent to the opening portion from the extending direction of the pin hole.

3. The piston of claim 2, wherein the opening portion of the oil flow path is formed in an elliptic shape having a major-axis direction extending along the extending direction of the pin hole.

4. The piston of claim 1, wherein
the oil flow path includes a cooling chamber formed in an inside of the piston head, and a communication path establishing communication between the opening portion and the cooling chamber, and
the opening portion is formed to be coaxial with the communication path.

5. The piston of claim 1, wherein the opening portion forms an inflow portion through which oil from an oil jet flows into the oil flow path.

6. An internal combustion engine comprising:
the piston of claim 1; and
an oil jet capable of jetting oil, and capable of causing the jetted oil to flow into the oil flow path of the piston.

7. A vehicle comprising the internal combustion engine of claim 6.
